(19) United States
(12) Patent Application Publication
(10) Pub. No.: US 2026/0036273 A1
(43) Pub. Date: Feb. 5, 2026

(54) LIGHT FIXTURE WITH A DETACHABLE PHOTO-VOLTAIC MODULE

(71) Applicant: GLOBE ELECTRIC COMPANY INC., Montreal (CA)

(72) Inventors: Greta Pelaez Heredia, Beaconsfield (CA); Tal Barsheshat, Montreal (CA); Mark Bruno, Montreal (CA); Yi Xiao Che, Montreal (CA); Hugues Fonnet, Montreal (CA); Caroline Schmidt, Montreal (CA); John Colvin Deaton, Bowling Green, KY (US); Scott Blaise Tylicki, Bowling Green, KY (US)

(21) Appl. No.: 19/288,427

(22) Filed: Aug. 1, 2025

Related U.S. Application Data
(60) Provisional application No. 63/678,967, filed on Aug. 2, 2024.

(51) Int. Cl. F21S 9/03; F21V 3/02; F21V 15/02; F21V 17/06; F21V 27/00; F21Y 101/00; H02S 20/30; H02S 30/10; H02S 30/20; H02S 40/34

(52) U.S. Cl. CPC F21S 9/037; F21S 9/032; F21V 3/02; F21V 15/02; F21V 17/06; F21V 27/00; H02S 20/30; H02S 30/10; H02S 30/20; H02S 40/34; F21Y 2101/00

(57) ABSTRACT

This disclosure sets forth a light fixture with a photo-voltaic module that is both securable to and detachable from a light source housing. The photo-voltaic module is tethered to the light source housing by a cable, which is stored in, and retrieve from, the photo-voltaic module. The cable provides both a mechanical and electrical tether between the photo-voltaic module and the light source housing.

### FIELD OF THE DISCLOSURE

The present disclosure relates to lighting fixtures, specifically systems, devices, apparatuses, and methods associated with a lighting fixture including a detachable photo-voltaic power source.

### BACKGROUND

Lighting fixtures may be used to illuminate areas that lack adequate natural lighting (e.g., sunlight). Lighting fixtures may be powered using a photo-voltaic module. Photo-voltaic modules require an adequate amount of sunlight to produce electrical output that is capable of powering a light source. Photo-voltaic modules may be immovably positioned on a lighting fixture. Immovable positioning of a photo-voltaic module on a lighting fixture may compromise functionality of the lighting fixture, based on an inadequate amount of sunlight being received at both the light fixture and the photo-voltaic module, if the light fixture is placed in an area that does not have an adequate amount of sunlight.

There is a desire for a solution to the aforementioned problems.

### SUMMARY OF THE EMBODIMENTS

The disclosure herein relates to multiple embodiments of a photo-voltaic module that is secured to, and detachable from, a light source housing. The photo-voltaic module may be stowed in a first position that is on the light source housing and deployed in a second position that is not on the light source housing. The photo-voltaic module may share structural and cosmetic characteristics with the light source housing to appear uniform with the light source housing while in the stowed position. The detachable photo-voltaic module may be detachably stowed on the light source housing using a tongue and groove mechanical coupling. The photo-voltaic module may remain electrically connected to circuitry housed within the light source housing by a cable while deployed away from the light source housing. The cable tethering the light source housing and the photo-voltaic module power source may be pulled from the photo-voltaic module, and may be reinserted into the photo-voltaic module, based on repositioning of the photo-voltaic module relative to the light source housing.

In some implementations, a light fixture with a securable and detachable photo-voltaic module may include a power supply circuit and a light source housing. In some implementations, a light source housing may include a light source, an outwardly extending plateau, that extends from a top wall of the light source housing, and that the detachable photo-voltaic module is removably secured to, and a mounting bracket extending outwardly and away from the light source housing. In some implementations, the photo-voltaic module may have a pocket, that removably receives the outwardly extending plateau extending from the top wall of the light source housing and which is in electrical connection with the power supply circuit.

In some implementations, the detachable photo-voltaic module is stowed in a first position in which the outwardly extending plateau of the top wall of the light source housing is received within the pocket of the photo-voltaic module and securely affixes the detachable photo-voltaic module to the light source housing. In some implementations, the detachable photo-voltaic module is deployed in a second position in which the detachable photo-voltaic module is displaced from the outwardly extending plateau of the top wall of the light source housing.

In some implementations, a photo-voltaic module has a configuration which matches the configuration of the top wall and sits on the top wall of the light source housing when stowed in the first position, and retained on the outwardly extending plateau of the light source housing. In some implementations, photo-voltaic module may have a predefined height when on the top wall of the light source housing which matches the height of the mounting bracket based on the photo-voltaic module being secured to the outwardly extending plateau of the light source housing.

In some implementations a photo-voltaic module includes a photo-voltaic cell, a photo-voltaic cell frame that at least partially surrounds the photo-voltaic cell, and a photo-voltaic module mounting bracket that is secured to, and detaches from, the photo-voltaic cell frame. In some implementations a light fixture with a securable and detachable photo-voltaic module may include a photo-voltaic module mounting bracket arm that separates the photo-voltaic cell frame and the photo-voltaic module mounting bracket.

In some implementations, a photo-voltaic cell frame swivels relative to the photo-voltaic module mounting bracket arm. In some implementations, a photo-voltaic module mounting bracket arm and the photo-voltaic module mounting bracket simultaneously detach from the photo-voltaic cell frame. In some implementations, a photo-voltaic module mounting bracket arm and the photo-voltaic module mounting bracket collapse into the pocket of the photo-voltaic module. In some implementations, a pocket of the photo-voltaic module extends inwardly into the photo-voltaic frame.

In some implementations a light fixture with a securable and detachable photo-voltaic module may include a post extending outwardly from within the pocket of the photo-voltaic module, wherein a cable electrically connecting the photo-voltaic module to the power supply circuit wraps around the post based on the detachable photo-voltaic module being stowed in the first position, and unwraps around the post based on the detachable photo-voltaic module being deployed in the second position. In some implementations a light fixture with a securable and detachable photo-voltaic module may include a coil that is secured within the pocket of the photo-voltaic module, wherein a cable electrically connecting the photo-voltaic module to the light source housing retracts around the coil based on the photo-voltaic module being repositioned from the deployed second position to the stowed first position.

In some implementations a light fixture with a securable and detachable photo-voltaic module may include an annular light source diffuser which surrounds the light source and which is transparent, translucent, or opaque. In some implementations, a light source housing includes four columns extending below the top wall of the light source housing, and a bottom wall connected to the four columns. In some implementations, an annular light source diffuser is at least partially surrounded by the light source housing. In some implementations, an annular light source diffuser is cylindrical. In some implementations, an annular light source diffuser extends below a top wall of a light source housing, and four columns extend further below the top wall of the light source housing than the annular light source diffuser.

In some implementations, a photo-voltaic module is secured to a light source housing by one or more of a magnetic lock, a mechanical lock, and a friction lock. In some implementations, a photo-voltaic module is secured to a light source housing by a tongue and groove lock.

In some implementations a light fixture with a securable and detachable photo-voltaic module may include a light source housing including an outwardly extending plateau that extends from a top wall of the light source housing, and that the detachable photo-voltaic module secures to and detaches from, a mounting bracket that affixes the light source housing to a surface; and a pocket, of the photo-voltaic module, that removably receives the outwardly extending plateau extending from the top wall of the light source housing.

In some implementations, a light fixture with a securable and detachable photo-voltaic module nay include a light source housing including an outwardly extending plateau that extends from a portion of the light source housing, and that the detachable photo-voltaic module secures to and detaches from, and a pocket, of the photo-voltaic module, that removably receives the outwardly extending plateau extending from the portion of the light source housing.

### DESCRIPTION OF THE DRAWINGS

FIG. 1 is a front-downward perspective view of a photo-voltaic module that is securable to, and detached from, a light source housing.

FIG. 2 is a rear-upward perspective view of a photo-voltaic module that is securable to, and detached from, a light source housing.

FIG. 3 is a side view of a photo-voltaic module that is securable to, and detached from, a light source housing.

FIG. 4 is a rear-upward focus view of a photo-voltaic module that is securable to, and detached from, a light source housing.

FIG. 5 is a rear-upward focus view of a photo-voltaic module that is securable to, and detached from, a light source housing. The photo-voltaic module mounting bracket and photo-voltaic module mounting bracket arm are depicted as being detached from the photo-voltaic module.

FIG. 6 is a front-downward perspective view of a photo-voltaic module that is secured to, and detachable from, a light source housing.

FIG. 7 is a side view of a photo-voltaic module that is secured to, and detachable from, a light source housing.

FIG. 8 is a cross-sectional side view of a photo-voltaic module that is secured to, and detachable from, a light source housing.

FIG. 9 is a block diagram of example circuitry which may be included in a light source housing.

### DETAILED DESCRIPTION

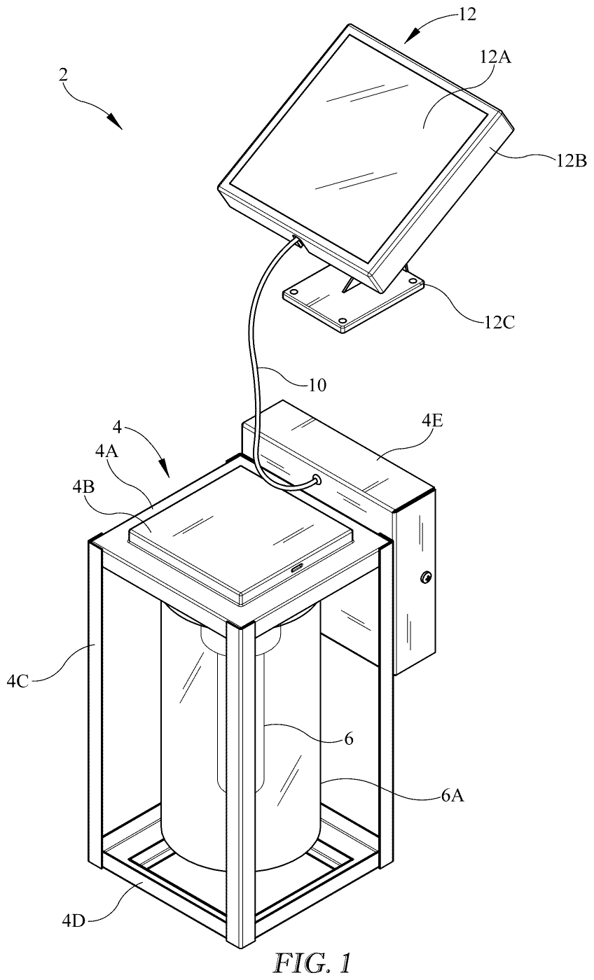

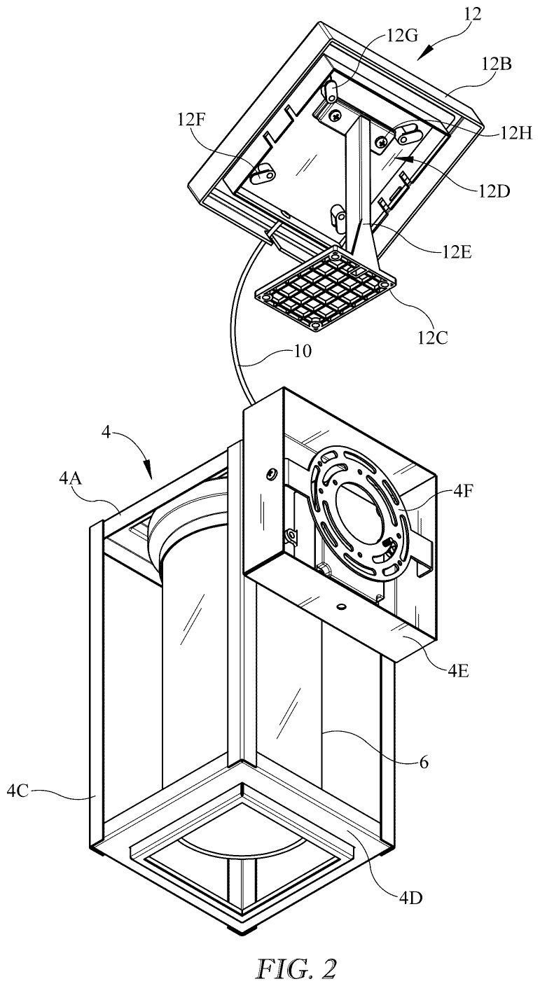

FIG. 1 depicts light fixture 2, which may include light source housing 4 and photo-voltaic module 12. Light source housing 4 may include a top wall 4A, an outwardly extending plateau 4B, one or more sidewall columns 4C, a bottom wall 4D, a mounting bracket housing 4E, and a light source housing mounting bracket 4F. Light source 6 may extend downwards from top wall 4A of the light source housing 4. Light source 6 may be guarded by light source diffuser 6A, which may also extend downwards from top wall 4A of the light source housing 4. Mounting bracket housing 4E may house a light source housing mounting bracket 4F (depicted subsequently in FIG. 2), which may affix light source housing 4 to an adjacent surface, such as a wall or post.

Photo-voltaic module 12 may include at least one photo-voltaic cell 12A, photo-voltaic cell frame 12B, photo-voltaic module mounting bracket 12C, photo-voltaic module mounting bracket arm 12E (depicted subsequently in FIG. 2), photo-voltaic cell frame pocket 12D (depicted subsequently in FIG. 2), photo-voltaic cell frame hook 12F (depicted subsequently in FIG. 2), photo-voltaic cell frame peg 12G (depicted subsequently in FIG. 2), and photo-voltaic cell frame fastener 12H (depicted subsequently in FIG. 2).

Photo-voltaic module 12 may secure to, and detach from, top wall 4A of light source housing 4. Specifically, photo-voltaic module 12 may secure to, and detach from, outwardly extending plateau 4B located on top of top wall 4A of light source housing 4. Photo-voltaic module 12 may secure to outwardly extending plateau 4B using one or more of a friction lock, mechanical lock, magnetic lock, and adhesive lock, etc. For example, photo-voltaic module 12 may secure to outwardly extending plateau 4B using a tongue and groove lock, in which a tongue of photo-voltaic module 12 detachably interlocks with a corresponding groove of outwardly extending plateau 4B. In some implementations, photo-voltaic cell frame 12B at least partially surrounds photo-voltaic cell 12A, such that a tongue of photo-voltaic cell frame 12B interfaces with a corresponding groove of outwardly extending plateau 4B. In other implementations, the outwardly extending plateau 4B may extend outwardly over a substantial portion of the top wall 4A of the light source housing 4 to receive the photo-voltaic cell frame 12B.

Photo-voltaic module 12 may be stowed in a first position in which the outwardly extending plateau 4B of the top wall 4A of the light source housing 4 is received within pocket 12D of the photo-voltaic module 12. Photo-voltaic module 12 may be secured to, and detachable from, light source housing 4 based on being stowed in the first position. Photo-voltaic module 12 may also be deployed in a second position in which photo-voltaic module 12 is displaced from the outwardly extending plateau 4B of the top wall 4A of the light source housing 4. Photo-voltaic module 12 may be detached from, and securable to, light source housing 4 based on being deployed in the second position. Photo-voltaic module 12 may be active or inactive based on being stowed or deployed. In some implementations, photo-voltaic module 12 is active both in a stowed position and deployed position.

Photo-voltaic module 12 may be tethered to light source housing 4 by cable 10. Specifically, photo-voltaic module 12 may be tethered to mounting bracket housing 4E by cable 10. Cable 10 may be of various lengths, including, for example, fifteen standard feet. Cable 10 may be manually wrapped and unwrapped around photo-voltaic cell frame hook 12F and/or photo-voltaic cell frame peg 12G. Cable 10 may be wrapped and unwrapped around a coil that exerts a natural retractive force to pull cable 10 towards photo-voltaic module 12. Thus, in some implementations, a coil may naturally retract cable 10. Photo-voltaic module 12 may be repositioned and/or relocated from light source housing 4 based on a length of cable 10 that is pulled from the photo-voltaic module 12.

For example, as mentioned above, mounting bracket housing 4E may house a light source housing mounting bracket 4F which may affix light source housing 4 to an adjacent surface, such as a wall or post. Photo-voltaic module 12 may be repositioned from light source housing 4, and/or any adjacent surface light source housing 4 is affixed thereto, based on a segment of wrapped and/or unwrapped cable 10. Put another way, capability of photo-voltaic module 12 to be repositioned from light source housing 4 may be proportional to an amount of cable 10 that is wrapped and/or unwrapped. For example, if cable 10 is fifteen standard feet, and three standard feet of cable 10 is unwrapped, then photo-voltaic module 12 may be capable of being repositioned exactly or approximately three feet from light source housing 4. Cable 10 may include a rigid and/or flexible segment, and photo-voltaic module 12 may be positioned, for example, less than three standard feet from light source housing 4 even if three standard feet or more of cable 10 is unwrapped.

Cable 10 may be reinserted into photo-voltaic module 12 based on the photo-voltaic module 12 repositioning closer to the light source housing 4 (producing slack in the cable 10) and cable 10 being re-wrapped, for example, around hook 12F and peg 12G located inside photo-voltaic cell frame pocket 12D. Cable 10 may include one or more cable 10 segments, and a first cable 10 segment may remain wrapped in photo-voltaic module 12 while a second cable 10 segment may be unwrapped from photo-voltaic module 12. Unwrapping a second cable 10 segment may allow photo-voltaic module 12 to be relocated relative to light source housing 4. Relocation of photo-voltaic module 12 relative to light source housing 4 may be defined by the amount of cable 10 unwrapped. Put another way, an amount of slack in cable 10, based on cable 10 being unwrapped, may define a maximum displacement potential for photo-voltaic module 12 relative to light source housing 4.

Column 4C may connect top wall 4A with bottom wall 4D. In some implementations, only one column 4C may connect top wall 4A with bottom wall 4D. In some implementations, a plurality of columns 4C may connect top wall 4A with bottom wall 4D. For example, there may be four columns 4C connecting top wall 4A with bottom wall 4D. A transparent or non-transparent surface may be placed between columns 4C. Bottom wall 4D may be partially hollow. In some implementations, a transparent or non-transparent surface may be placed between columns 4C. Columns 4C may extend downwards from the top wall 4A to bottom wall 4D.

FIG. 2 is a rear-upward perspective view of light fixture 2, in which photo-voltaic module 12 is removably secured to, but detachable from, light fixture 2. FIG. 2 also depicts photo-voltaic module 12 and light source housing 4. Specifically, FIG. 2 provides a perspective view of the photo-voltaic cell frame pocket 12D, photo-voltaic module mounting bracket arm 12E, photo-voltaic cell frame hook 12F, photo-voltaic cell frame peg 12G, photo-voltaic cell frame fastener 12H, and light source housing mounting bracket 4F.

Photo-voltaic module mounting bracket arm 12E extends from photo-voltaic module mounting bracket 12C and connects to photo-voltaic cell frame 12B. In some implementations, photo-voltaic module mounting bracket arm 12E separates the photo-voltaic cell frame 12B and the photo-voltaic module mounting bracket 12C. Photo-voltaic module mounting bracket arm 12E may improve photo-voltaic potential of photo-voltaic cell 12A by extending photo-voltaic cell 12A above an object adjacent to photo-voltaic module mounting bracket 12C. Photo-voltaic module mounting bracket arm 12E may also improve the longevity of photo-voltaic module 12 components by raising photo-voltaic module 12 above a level in which elements (such as water) and debris may accumulate. In some implementations, photo-voltaic module mounting bracket 12C is attached to photo-voltaic module mounting bracket arm 12E, and mounting bracket 12C and mounting bracket arm 12E may be simultaneously secured or detached by adjusting photo-voltaic cell frame fastener 12H. In some implementations, photo-voltaic module mounting bracket arm 12E may connect with photo-voltaic module mounting bracket 12C and/or photo-voltaic cell frame 12B using an adjustable joint, such as a ball joint. Accordingly, in some implementations, photo-voltaic module mounting bracket 12C and/or photo-voltaic cell frame 12B may rotate/swivel relative to photo-voltaic module mounting bracket arm 12E.

In some implementations, the bracket arm 12E may be foldable and secured within the pocket 12D of the photo-voltaic module 12. Photo-voltaic cell pocket 12D may extend inwardly into photo-voltaic cell frame 12B. For example, in some implementations, the pocket 12D may be sized appropriately to receive the bracket arm 12E. For example, the bracket arm 12E may have hinges and/or other mechanical devices allowing the bracket arm to entirely fold up flat into a storage orientation and then be received within the pocket. In other implementations, the bracket arm 12E may be removably securable to the photo-voltaic module 12.

Photo-voltaic cell frame 12B may include a photo-voltaic cell frame pocket 12D. Photo-voltaic cell frame pocket 12D may be configured to receive outwardly extending plateau 4B of the light source housing 4. Photo-voltaic module 12 may become flush/level with top wall 4A and/or mounting bracket housing 4E of the light source housing 4 based on the photo-voltaic module 12 receiving (e.g., being secured to) the outwardly extending plateau 4B of the light source housing 4. As discussed above, photo-voltaic cell frame pocket 12D may detachably secure with outwardly extending plateau 4B using various means, such as friction, magnetic, mechanical, adhesive, etc. Additionally, photo-voltaic cell frame pocket 12D may receive cable 10. For example, photo-voltaic cell frame pocket 12D may include hook 12F and peg 12G, which cable 10 may be configured to wrap and/or unwrap around, so that segments of cable 10 may be stored or retrieved as required for positioning of photo-voltaic module 12 relative to light source housing 4.

In some implementations, photo-voltaic module mounting bracket arm 12E and photo-voltaic module mounting bracket 12C may be configured to modularly fit inside photo-voltaic cell frame pocket 12D. For example, photo-voltaic module mounting bracket arm 12E and photo-voltaic module mounting bracket 12C may rotate respective to each other to fit inside photo-voltaic cell frame pocket 12D. In some implementations, photo-voltaic cell frame 12B, photo-voltaic module mounting bracket arm 12E, and/or photo-voltaic module mounting bracket 12C may be completely detachable relative to each other. Thus in some implementations, photo-voltaic module mounting bracket 12C and photo-voltaic module mounting bracket arm 12E may collapse into photo-voltaic cell frame pocket 12D. In some implementations, photo-voltaic module mounting bracket arm 12E and photo-voltaic module mounting bracket 12C may be a unitary piece and may be added and removed as such.

Light source housing mounting bracket 4F is depicted as being at least partially within mounting bracket housing 4E. One or more fasteners may be configured to pass through mounting bracket 4F and secure mounting bracket 4F to a surface. Light source housing 4 may secured a surface simultaneous or subsequent to mounting bracket 4F securing to the surface. For example, in some implementations, mounting bracket 4F may be detached from other aspects of light source housing 4, secured to a surface, and then the other aspects of light source housing 4 may be reattached to mounting bracket 4F while mounting bracket 4F is secured to the surface. One or more other fasteners may also be configured to pass through and secure mounting bracket housing 4E to mounting bracket 4F. Mounting bracket 4F may extend outwardly and away from light source housing 4.

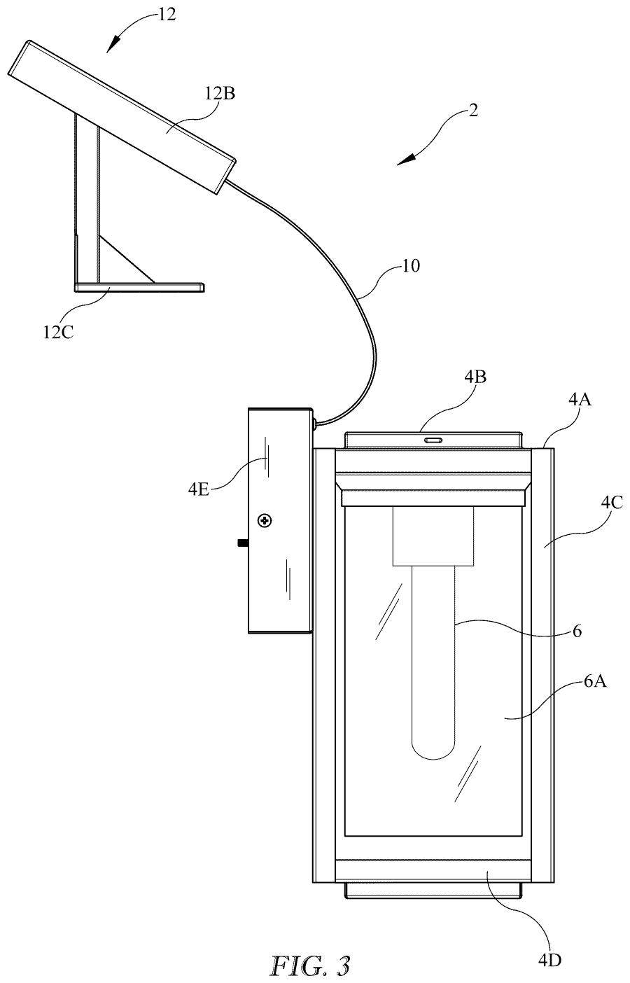

FIG. 3 is a side view of light fixture 2, in which photo-voltaic module 12 is secured to, but detachable from, light source housing 4. As depicted in FIG. 3, sidewall column 4C may extend further away from top wall 4A of the light source housing 4 than light source diffuser 6A. Additionally, top wall 4A may be wider than light source diffuser 6A. In some implementations, light source diffuser 6A may be wider and/or longer than light source 6.

In some implementations, light source diffuser 6A may be opaque. In some implementations, light source diffuser 6A may be translucent. In some implementations, light source diffuser 6A maybe transparent. Light source diffuser 6A may be at least partially surrounded by light source housing 4. Light source diffuser 6A may be of various shapes, sizes, and textures. For example, light source diffuser 6A may be cylindrical and/or annular, and may be sized to at least partially fit inside, and be at least partially surrounded by, light source housing 4.

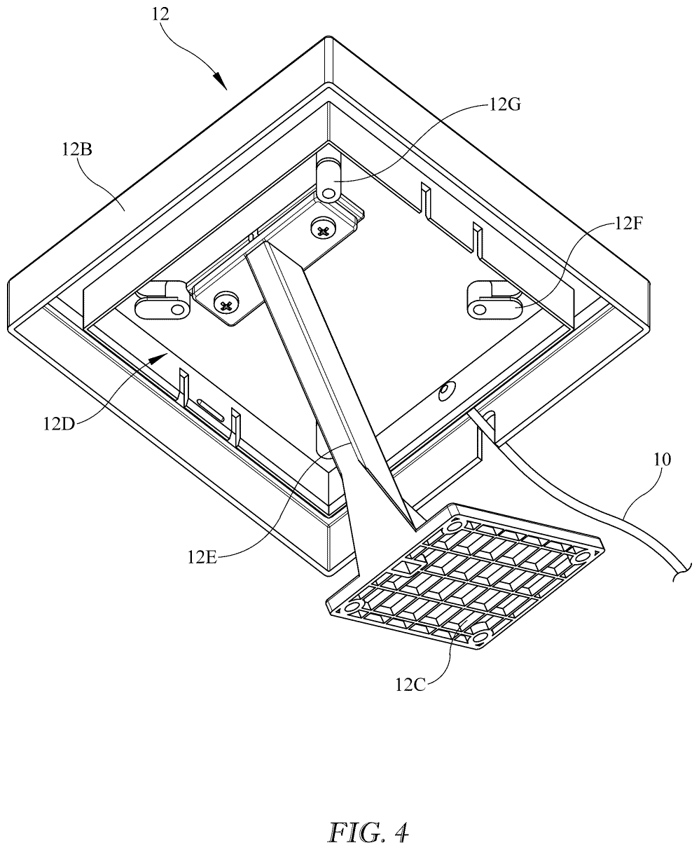

FIG. 4 is a rear-upward focus view of photo-voltaic module 12. In some implementations, photo-voltaic module 12 may include photo-voltaic cell frame hook 12F and photo-voltaic cell frame peg 12G. Photo-voltaic cell frame hook 12F may include a first portion and a second portion, and cable 10 may wrap around a portion a first portion of hook 12F and the second portion of hook 12F may prevent the cable 10 from sliding down and off the first portion. Hook 12F may be especially beneficial for a long cable 10 which may wrap around hook 12F several times before coming off. Similar to hook 12F, cable 10 may wrap around peg 12G. In some implementations, peg 12G may be angled relative to photo-voltaic cell frame 12B to prevent cable 10 from slipping off of peg 12G.

FIG. 4 also depicts a close-up view of photo-voltaic module mounting bracket 12C. In some implementations, photo-voltaic module mounting bracket 12C may include textures on a bottom surface. Textures on the bottom surface of photo-voltaic module mounting bracket 12C may improve grip of photo-voltaic module mounting bracket 12C on an adjacent surface. Photo-voltaic module mounting bracket 12C may also include apertures for one or more fasteners to pass through and secure photo-voltaic module mounting bracket 12C to a surface beneath it.

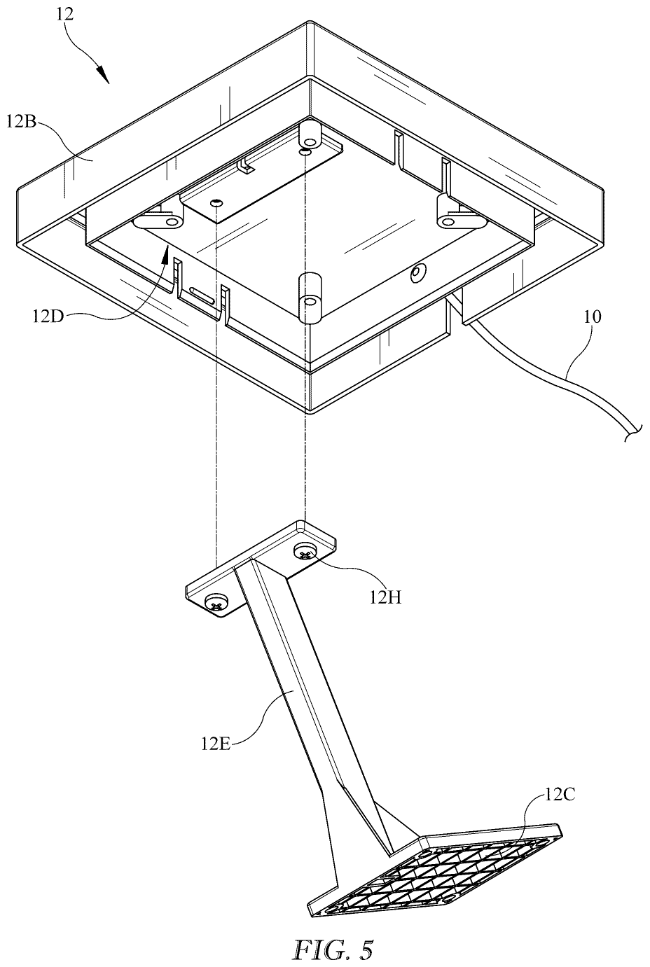

FIG. 5 depicts a rear-upward focus view of photo-voltaic module 12, with photo-voltaic module mounting bracket 12C and photo-voltaic module mounting bracket arm 12E being detached. Photo-voltaic cell frame fastener (e.g., such as one or more screws) 12H may be configured to fasten photo-voltaic module mounting bracket arm 12E to photo-voltaic cell frame 12B. In some implementations, other fastening means may be used, such as friction, adhesive, other mechanical means (e.g., tongue and groove, ball and socket, etc.), magnetic, etc. Additionally, the location, size, and shape, of the means of fastening photo-voltaic module mounting bracket arm 12E to photo-voltaic cell frame 12B may vary. For example, photo-voltaic module mounting bracket arm 12E may be secured to a side of photo-voltaic cell frame 12B or a center of photo-voltaic cell frame pocket 12D.

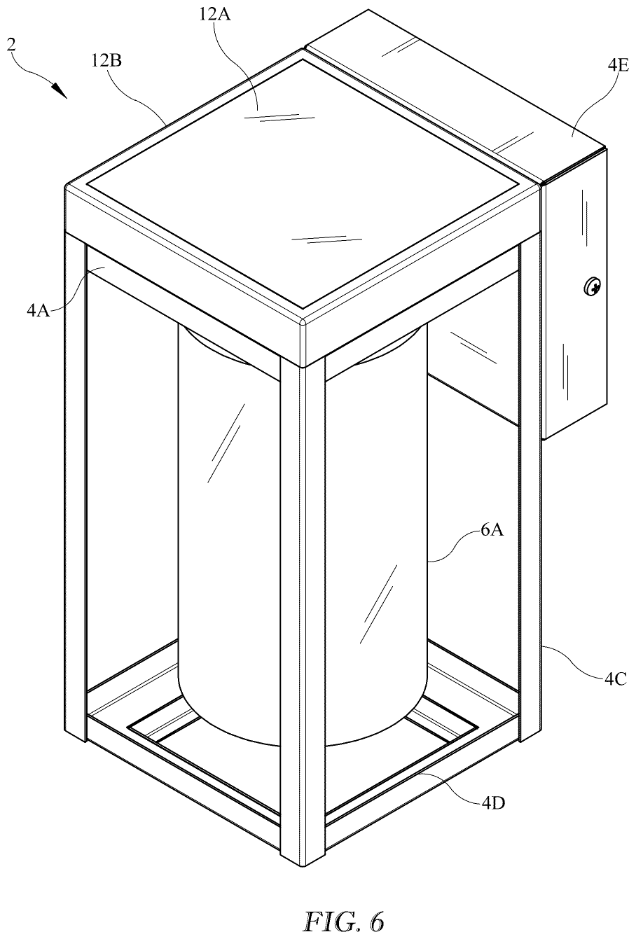

FIG. 6 is a front-downward perspective view of light fixture 2, with photo-voltaic module 12 secured to, but detachable from, light source housing 4. Photo-voltaic module 12 may be shaped and sized to minimize aesthetic contrast with light source housing 4. For example, photo-voltaic module 12 may be the same width as the top wall 4A of the light source housing 4, and/or the mounting bracket housing 4E. As another example, photo-voltaic module 12 may be configured to have a height level with mounting bracket housing 4E. In some implementations, photo-voltaic module 12 may have a predefined height or a modifiable height. Photo-voltaic module 12 may have a configuration which matches the configuration of the top wall 4A. Photo-voltaic module 12 may sit and/or be retained on top wall 4A and/or outwardly extending plateau 4B of the light source housing 4 while stowed in the first position.

Edges, heights, contours, textures, colors, etc., may match between photo-voltaic module 12 and light source housing 4. For example, the corners of both photo-voltaic module 12 and light source housing 4 may be beveled. As another example, photo-voltaic module 12 may have a height that matches a height of mounting bracket housing 4E based on photo-voltaic module 12 being stowed in a position on light source housing 4. Put another way, photo-voltaic module 12 may be level with mounting bracket housing 4E and/or top wall 4A when stowed in a first position on outwardly extending plateau 4B.

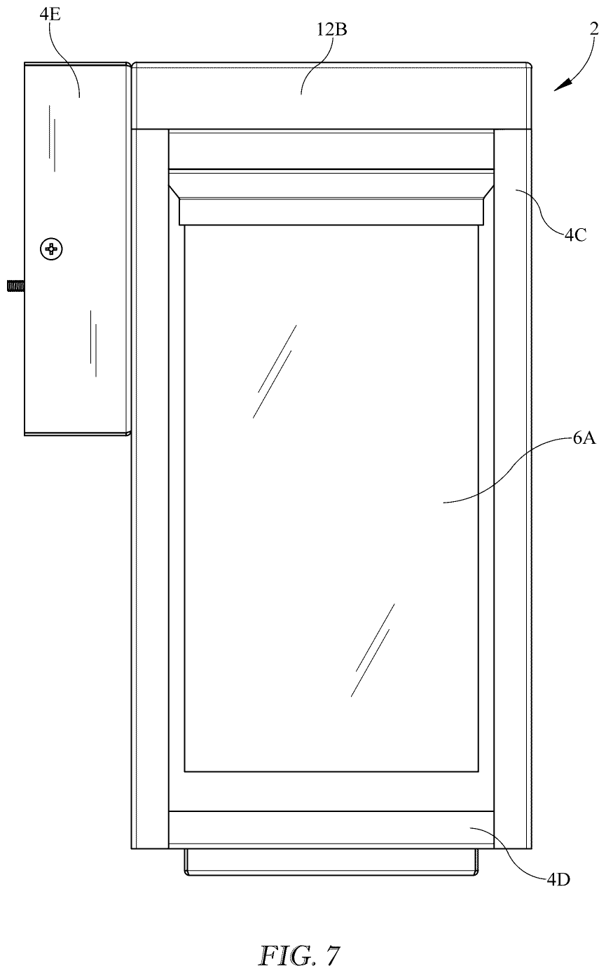

FIG. 7 is a side view of light fixture 2, with photo-voltaic module 12 secured to, but detached from, the light source housing 4. As discussed previously, photo-voltaic module 12 may be shaped, sized, contoured, textured, colored, and/or made from materials so as to appear uniform with light source housing 4. Accordingly, photo-voltaic module 12 may have a width that is equal to a width of the top wall 4A and/or mounting bracket housing 4E of the light source housing 4.

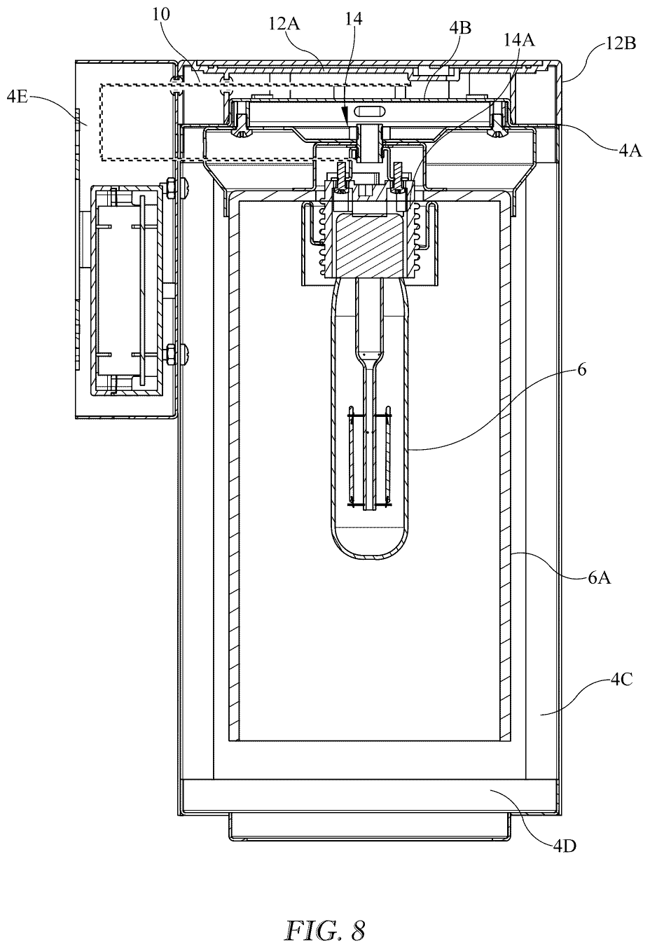

FIG. 8 is a cross-sectional side view of light fixture 2 with photo-voltaic module 12 secured to, but detachable from, the light source housing 4. Circuitry 14 is depicted, and in some implementations, may electrically connect light source 6 with light source housing 4, including mounting bracket housing 4E to which cable 10 may be tethered, and photo-voltaic module 12.

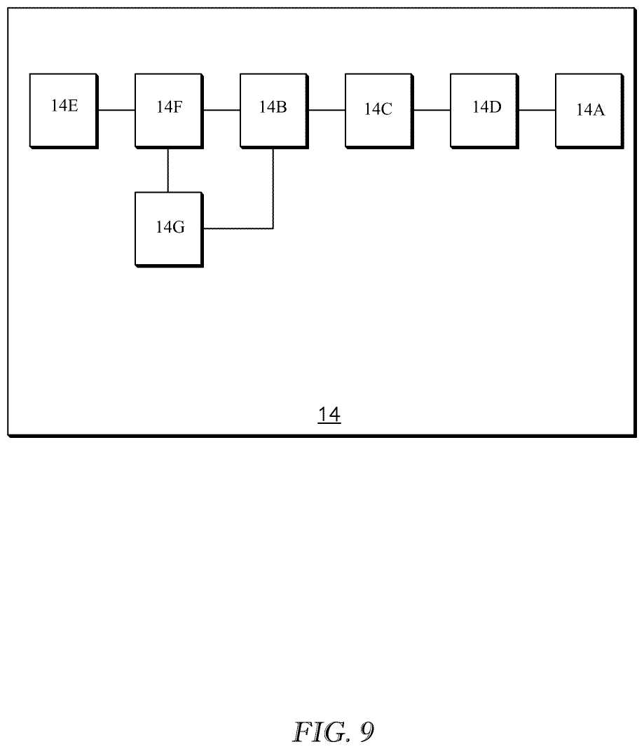

FIG. 9 is a block diagram of example circuitry which may be included in light fixture 2. Circuitry 14 may include a light socket 14A, power circuitry 14B, control circuitry 14C, transmission circuitry 14D, photo-voltaic cell circuitry 14E, battery 14F, and/or light sensor 14G.

Components of circuitry 14 may include one or more resistors, capacitors, inductors, diodes, transistors, transformers, relays, fuses, transmitters, receives, processors, memory storage devices (including transitory and/or non-transitory computer readable mediums), interfaces (include one or more of visual, audio, and/or haptic interfaces), etc. Aspects of circuitry 14 (for example, 14A-14G) may communicate and overlap. Put another way, aspects of circuitry 14 (e.g., 14A-14G) may or may not operate mutually exclusively, and may or may not include mutually exclusive components and/or functions. For example, a transformer may be shared by both power circuitry 14B and control circuitry 14C.

Light socket 14A may electrically and/or mechanically connect with one or more light emitting sources. Alternatively, light socket 14A may simply be an LED light source which may replace a light socket and light source. For example, the socket and other hardware may be replaced with an LED substrate containing the diode and/or semiconductors necessary to produce illumination. Associated drivers, power supplies, lens, substrates and related reflectors may be added as needed. In the various descriptions herein, the light socket and associated hardware may be used interchangeably with LED hardware and the like as are known in the art. The light emitting source may include one or more of a fluorescent light source, incandescent light source, CFL light source, halogen light source, LED light source, etc.

Power circuitry 14B may include one or more transformers, regulators, and related circuitry for providing and regulating electricity to the light illumination sources. For example, power circuitry 14B may include a voltage regulator circuit that may regulate voltage from the photo-voltaic cell circuitry 14E and/or the battery 14F. As an example, photo-voltaic cell circuitry 14E may have inconsistent power output based on the time of day (e.g., producing less wattage when the sun is low, and producing more wattage when the sun is high), and the power circuitry 14B may regulate power supplied by photo-voltaic cell circuitry 14E and/or the light source(s). Power circuitry 14B may regulate power supplied by battery 14F and may also control charging and recharging of the battery. As an example, battery 14F may supply only 12 VDC, but light socket 14A may use 3 VDC while a light sensor 14G may use 5 VDC, so power circuitry 14B may regulate the 12 VDC output of the battery 14F to properly supply light sensor 14G and/or light socket 14A. As well, power circuitry may provide regulated electrical power to the drivers and or control circuitry of the light source.

Control circuitry 14C may control aspects of circuitry 14. For example, light socket 14A may only energize based on light sensor 14G sensing low lighting conditions, and/or vice versa, light socket 14A may not energize based on light sensor 14G sensing high lighting conditions. Control circuitry 14C may control when light socket 14A emits light based on signals from light sensor 14G. Control circuitry 14C may also communicate with one or more processors, which may include instructions for functions that control circuitry 14C should cause. Control circuitry 14C may cause one or more functions based on a timer, remote signal, etc.

Transmission circuitry 14D may transmit one or more electrical signals between one or more electrical components, which may or may not be directly hardwired with circuitry 14. Put another way, one or more electrical components that transmission circuitry 14D may communicate with may not necessarily be included in circuitry 14. For example, in some implementations, Wi-Fi, Bluetooth, and/or other communication protocols may be used to exchange signals with one or more components which may or may not be directly hardwired to circuitry 14, and/or which may be remotely connected with circuitry 14. Transmission circuitry 14D, may include one or more transmitters, receivers, modulators, transformers, memories, processors, etc.

Photo-voltaic cell circuitry 14E may conduct power generated from photo-voltaic module 12. Photo-voltaic cell circuitry 14E may include a photo-voltaic cell 12A and/or cable 10. Cable 10 may include one or more conductors which may conduct power generated from photo-voltaic module 12.

Battery 14F may be connected to photo-voltaic cell circuitry 14E, and/or may store power generated by photo-voltaic circuitry 14E. Battery 14F may be connected to photo-voltaic cell circuitry 14E via other circuitry discussed herein, such as power circuitry 14B (which may regulate power supplied by photo-voltaic cell circuitry 14E), and/or such as control circuitry 14C (which may regulate when power may be supplied by photo-voltaic cell circuitry 14E and/or power circuitry 14B to battery 14F based on light sensor 14G). Battery 14F may be one or more of rechargeable and/or replaceable.

Light sensor 14G may transmit one or more signals which may indicate one or more of low light conditions, medium light conditions, high light conditions, unknown light conditions, etc., to one or more components of circuitry 14. Other sensors may also be used to perform similar functions, such as a motion sensor, proximity sensor, IR sensor, ultrasound sensor, temperature sensor, humidity sensor, etc., and signals from other sensors may modify operation of circuitry 14. For example, a temperature sensor indicating a high temperature may preclude a light source from emitting light even if a light sensor is indicating low lighting conditions, which would normally cause the light source to emit light.

The block diagram of FIG. 9 is only an example of how one or more components (14A-14G) of circuitry 14 may be configured and/or operated in a given setting. For example, Photo-voltaic cell circuitry 14E may provide electricity to battery 14F. Battery 14F may provide electricity to power circuitry 14B. Provision of electricity to power circuitry 14B by battery 14F may be based on light sensor 14G (specifically, a signal which may be indicative of low light conditions). Power circuitry 14B may transform electricity provided by battery 14F into electricity that is useable for other components of circuitry 14. Power circuitry 14B may provide electricity to control circuitry 14C, which may control transmission circuitry 14D, used to transmit one or more signals between one or more components, such as light socket 14A.

In some implementations, photo-voltaic cell circuitry 14E may generate electricity based on photo-voltaic module 12 receiving photons, transmission circuitry 14D may connect the photo-voltaic cell circuitry 14E with a power circuit 14B to rectify and/or transform voltage if necessary (it is understood that photo-voltaic cells may naturally generate DC current which may not need to be transformed or rectified), control circuitry 14C may process and route electrical supply as needed, and the light socket 14A may provide an electrical outlet for light source 6 to be quickly connected to aspects of circuitry 14.

In some implementations, battery 14F may be charged by photo-voltaic cell circuitry 14E. Battery 14F may also connect to transmission circuitry 14D and provide electricity to the transmission circuitry 14D, similar to photo-voltaic cell circuitry 14E. In some implementations, a light sensor 14G, such as a photocell sensor, may determine lighting conditions, and may determine whether photo-voltaic cell circuitry 14E provides electricity to transmission circuitry 14D and/or battery 14F.

For example, depending on placement of light fixture 2, it may be desirable for light source 6 to output light during daytime and/or nighttime. If daytime light is sought, then photo-voltaic cell circuitry 14E may be connected with transmission circuitry 14D during the day, such that electricity produced by photo-voltaic cell circuitry is almost instantaneously provided to transmission circuitry 14D, and as discussed above, used to power light source 6. If nighttime light is sought, then light sensor 14G may identify when it is daytime, and route electricity produced by photo-voltaic cell circuitry 14E during daytime to battery 14F, so that the electricity may be stored and used later during nighttime.

One or more aspects of circuitry 14 depicted in FIG. 9 may be stored in light source housing 4, cable 10, and/or photo-voltaic module 12. Light source housing 4, cable 10, and/or photo-voltaic module 12 may be in electrical connection with one or more aspects of circuitry 14.

We claim:

1. A light fixture with a securable and detachable photo-voltaic module, comprising:
a power supply circuit;
a light source housing including:
a light source; an outwardly extending plateau, that extends from a top wall of the light source housing, and that the detachable photo-voltaic module is removably secured to, and
a mounting bracket extending outwardly and away from the light source housing;
the photo-voltaic module having a pocket, that removably receives the outwardly extending plateau extending from the top wall of the light source housing and which is in electrical connection with the power supply circuit,
wherein the detachable photo-voltaic module is stowed in a first position in which the outwardly extending plateau of the top wall of the light source housing is received within the pocket of the photo-voltaic module and securely affixes the detachable photo-voltaic module to the light source housing, and
wherein the detachable photo-voltaic module is deployed in a second position in which the detachable photo-voltaic module is displaced from the outwardly extending plateau of the top wall of the light source housing.

2. The light fixture of claim 1, wherein the photo-voltaic module has a configuration which matches the configuration of the top wall and sits on the top wall of the light source housing when stowed in the first position, and retained on the outwardly extending plateau of the light source housing.

3. The light fixture of claim 2, wherein the photo-voltaic module has a predefined height when on the top wall of the light source housing which matches the height of the mounting bracket based on the photo-voltaic module being secured to the outwardly extending plateau of the light source housing.

4. The light fixture of claim 1, wherein the photo-voltaic module comprises:
a photo-voltaic cell;
a photo-voltaic cell frame that at least partially surrounds the photo-voltaic cell; and
a photo-voltaic module mounting bracket that is secured to, and detaches from, the photo-voltaic cell frame.

5. The light fixture of claim 4, further comprising a photo-voltaic module mounting bracket arm that separates the photo-voltaic cell frame and the photo-voltaic module mounting bracket.

6. The light fixture of claim 5, wherein the photo-voltaic cell frame swivels relative to the photo-voltaic module mounting bracket arm.

7. The light fixture of claim 5, wherein the photo-voltaic module mounting bracket arm and the photo-voltaic module mounting bracket simultaneously detach from the photo-voltaic cell frame.

8. The light fixture of claim 5, wherein the photo-voltaic module mounting bracket arm and the photo-voltaic module mounting bracket collapse into the pocket of the photo-voltaic module.

9. The light fixture of claim 4, wherein the pocket of the photo-voltaic module extends inwardly into the photo-voltaic frame.

10. The light fixture of claim 1, further comprising a post extending outwardly from within the pocket of the photo-voltaic module, wherein a cable electrically connecting the photo-voltaic module to the power supply circuit wraps around the post based on the detachable photo-voltaic module being stowed in the first position, and unwraps around the post based on the detachable photo-voltaic module being deployed in the second position.

11. The light fixture of claim 1, further comprising a coil that is secured within the pocket of the photo-voltaic module, wherein a cable electrically connecting the photo-voltaic module to the light source housing retracts around the coil based on the photo-voltaic module being repositioned from the deployed second position to the stowed first position.

12. The light fixture of claim 1, further comprising an annular light source diffuser which surrounds the light source and which is transparent, translucent, or opaque.

13. The light fixture of claim 12, wherein the light source housing includes four columns extending below the top wall of the light source housing, and a bottom wall connected to the four columns.

14. The light fixture of claim 13, wherein the annular light source diffuser is at least partially surrounded by the light source housing.

15. The light fixture of claim 14, wherein the annular light source diffuser is cylindrical.

16. The light fixture of claim 15, wherein the annular light source diffuser extends below the top wall of the light source housing, and the four columns extend further below the top wall of the light source housing than the annular light source diffuser.

17. The light fixture of claim 1, wherein the photo-voltaic module is secured to the light source housing by one or more of a magnetic lock, a mechanical lock, and a friction lock.

18. The light fixture of claim 1, wherein the photo-voltaic module is secured to the light source housing by a tongue and groove lock.

19. A light fixture with a securable and detachable photo-voltaic module, comprising:
a light source housing including an outwardly extending plateau that extends from a top wall of the light source housing, and that the detachable photo-voltaic module secures to and detaches from, and
a mounting bracket that affixes the light source housing to a surface; and
a pocket, of the photo-voltaic module, that removably receives the outwardly extending plateau extending from the top wall of the light source housing.

20. A light fixture with a securable and detachable photo-voltaic module, comprising:
a light source housing including an outwardly extending plateau that extends from a portion of the light source housing, and that the detachable photo-voltaic module secures to and detaches from, and
a pocket, of the photo-voltaic module, that removably receives the outwardly extending plateau extending from the portion of the light source housing.
